(19) United States
(12) Patent Application Publication
(10) Pub. No.: US 2015/0140160 A1
(43) Pub. Date: May 21, 2015

(54) Stack Mold System

(71) Applicant: NyproMold, Clinton, MA (US)

(72) Inventor: Tuan H. Nguyen, Milford, NH (US)

(21) Appl. No.: 14/541,854

(22) Filed: Nov. 14, 2014

Related U.S. Application Data
(60) Provisional application No. 61/904,230, filed on Nov. 14, 2013.

(51) Int. Cl. B29C 33/00; B29C 45/67; B29C 45/32

(52) U.S. Cl. CPC B29C 33/0088; B29C 45/32; B29C 45/67; B29C 2045/328
USPC 425/588

(57) ABSTRACT

A stack mold system includes, a first mold section, a second mold section, a central mold section disposed between the first and second mold sections, the first mold section and the central mold section configured to translate along a longitudinal axis relative to the second mold section. The stack mold system includes a hydraulic assembly coupled to the first mold section, the second mold section, and the central mold section. The hydraulic assembly is configured to maintain substantially equal distances between opposed faces of the adjacent mold sections when the first mold section translates between a first position and a second position along the longitudinal axis and regardless of whether the mold sections are disposed in a closed or open state, or are in transition between the closed and open states.

### RELATED APPLICATIONS

This patent application claims the benefit of U.S. Provisional Application No. 61/904,230, filed on Nov. 14, 2013, entitled, “Stack Mold System,” the contents and teachings of which are hereby incorporated by reference in their entirety.

### BACKGROUND

Stack molds have long been used for injection molding of plastic articles. For example, stack molds can include a moving mold plate, a mold center plate, and a fixed mold plate. The opposed faces of adjacent mold plates define one or more cavities which conform to a desired product. During operation, when the opposed faces of adjacent mold plates are brought together into abutting contact with each other, molten plastic is injected into the cavities through a conduit in one of the mold plates. The mold plates are then cooled which causes the molten plastic within the cavities to solidify to the desired shape. The mold plates are then separated and the finished plastic article is ejected from the stack mold.

To produce the finished plastic articles, conventional stack molds close and open the mold plates on a substantially continuous reciprocating basis. For example, to help separate the moving mold plates, conventional stack molds include a rack and pinion mechanism interconnected between adjacent mold plates. During operation, as the stack mold is opened and closed in the normal molding operation, the rack and pinion mechanism functions to separate, and maintain proper spacing between, the mold plates.

### SUMMARY

Conventional stack molds suffer from a variety of deficiencies. For example, standard clearances and manufacturing tolerances permit small variations in gear tooth size and pitch in the rack and pinion mechanisms in conventional stack molds. However, such variations cause the interacting surfaces of the meshing mechanisms to exhibit small gaps or spaces between their respective meshing teeth. The spaces can allow a limited amount of slack or backlash to enter into the system during operation of the rack and pinion mechanisms. With the presence of the backlash, the gears of the rack and pinion mechanisms are prone to wear and can require constant lubrication. Accordingly, conventional stack molds can be expensive to maintain. Additionally, the rack and pinion mechanisms limit the speed at which the mold plates can open and close relative to each other and to the mass that the centering device tries to move. For example, rack and pinion systems on conventional stack molds typically can open and close once every five seconds. This limits quantity of molded items that a stack mold system can produce.

By contrast to conventional stack molds, embodiments of the present innovation relate to a stack mold system having a hydraulic assembly configured to separate a set of mold plates and maintain substantially equidistant spacing between the parting lines of the mold plates in the system during operation. In one arrangement, the hydraulic system includes two opposed hydraulic elements that are disposed in fluid communication with each other via fluid conduits, such as fluid connectors or an internal manifold, to create a closed hydraulic system. During operation, as a moving mold section of the stack mold system translates away from a central mold section along a first direction, it pulls a first piston of the first hydraulic element and opens the first parting line. The movement of the piston forces fluid, such as oil, contained in the first hydraulic element into the second hydraulic element via a first fluid conduit. Flow of the fluid into the second hydraulic element causes the central mold section or sections to translate, relative to a second piston carried by the second hydraulic element, in the first direction away from a fixed mold section. This movement opens the second parting line and forces fluid contained by the second hydraulic element to flow into the first hydraulic element via a second conduit. The fluid flow within the stack mold system, as well as the translation of the moving mold section and the central mold section or sections, is reversed as the moving mold section of the stack mold system moves toward central mold section or sections.

Use of the hydraulic system maintains the substantially central positioning of the central mold section or sections within the stack mold system during operation. The hydraulic assembly also allows for relatively fast opening and closing of the stack mold system during operation increases the rate of opening and closing of the stack mold system to more than once every five seconds. This provides an increase in the production capability of the stack mold system.

In one arrangement, embodiments of the innovation relate to a stack mold system, comprising a stack mold assembly having a first mold section, a second mold section, and a central mold section disposed between the first and second mold sections and at least one hydraulic assembly connected to the first mold section, the second mold section, and the central mold section. The at least one hydraulic assembly comprises a first hydraulic element connected to the second mold section and to the central mold section and a second hydraulic element connected to the first mold section and to the central mold section, the second hydraulic element disposed in fluid communication with the first hydraulic element. The at least one hydraulic assembly is configured to translate the first mold section and the central mold section along a longitudinal axis relative to the second mold section

### BRIEF DESCRIPTION OF THE DRAWINGS

The foregoing and other objects, features and advantages will be apparent from the following description of particular embodiments of the innovation, as illustrated in the accompanying drawings in which like reference characters refer to the same parts throughout the different views. The drawings are not necessarily to scale, emphasis instead being placed upon illustrating the principles of various embodiments of the innovation.

FIG. 1 illustrates a side view of a schematic representation of a stack mold system, according to one arrangement.

FIG. 2 illustrates a side perspective view of a hydraulic assembly of a stack mold system, according to one arrangement.

FIG. 3 illustrates a side sectional view of the hydraulic assembly of FIG. 2 disposed in a first position, according to one arrangement.

FIG. 4 illustrates a side sectional view of the hydraulic assembly of FIG. 2 disposed in a second position, according to one arrangement.

FIG. 5 illustrates a top view of a stack mold system, according to one arrangement.

### DETAILED DESCRIPTION

Embodiments of the present innovation relate to a stack mold system having a hydraulic assembly configured to separate a set of mold plates and maintain substantially equidistant spacing between the parting lines of the mold plates in the system during operation. In one arrangement, the hydraulic system includes two opposed hydraulic elements that are disposed in fluid communication with each other via fluid conduits, such as fluid connectors or an internal manifold, to create a closed hydraulic system. During operation, as a moving mold section of the stack mold system translates away from a central mold section along a first direction, it pulls a first piston of the first hydraulic element and opens the first parting line. The movement of the piston forces fluid, such as oil, contained in the first hydraulic element into the second hydraulic element via a first fluid conduit. Flow of the fluid into the second hydraulic element causes the central mold section to translate, relative to a second piston carried by the second hydraulic element, in the first direction away from a fixed mold section. This movement opens the second parting line and forces fluid contained by the second hydraulic element to flow into the first hydraulic element via a second fluid conduit. The fluid flow within the stack mold system, as well as the translation of the moving mold section and the central mold section, is reversed as the moving mold section of the stack mold system moves toward the central mold section.

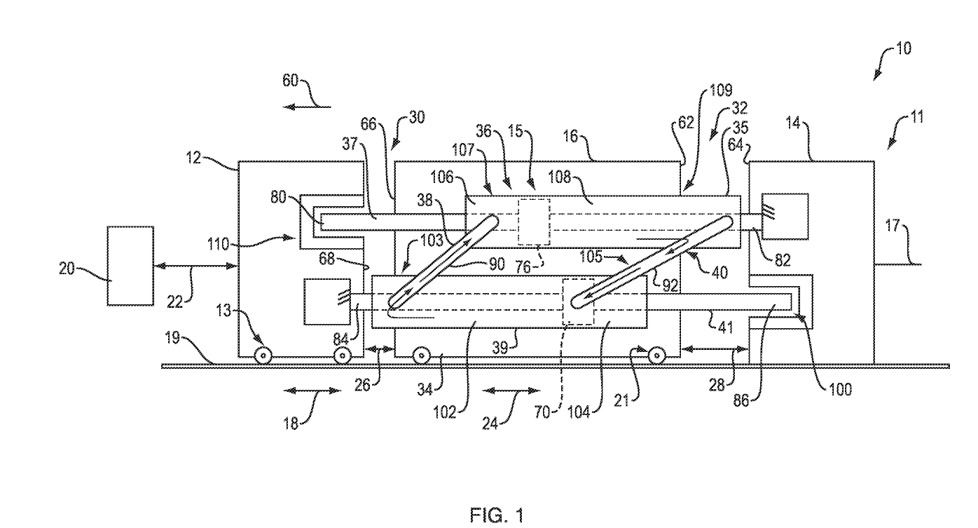

FIG. 1 illustrates a schematic depiction of a stack mold system 10, according to one arrangement. The stack mold system 10 includes a stack mold assembly 11 having a first mold section 12, a second mold section 14, and a central mold section 16 disposed between the first and second mold sections 12, 14. The stack mold system 10 also includes a hydraulic assembly 15 which is interconnected to the first, second, and central mold sections 12, 14, 16.

In one arrangement, the first mold section 12 is configured as a linearly translatable element and the second mold section 16 is configured as a fixed element. For example, the first mold section 12 can be supported by a set of wheels 13 which are configured to roll on a base 19 to translate the first mold section 12 along axis 18 while the second mold section 16 can be secured or connected to the base 19. In one arrangement, the central mold section 16 is also configured as a linearly translatable mold section configured to translate along axis 24 relative to the second mold section 16 and in response to linear translation of the first mold section 12. For example, the third mold section 16 can be supported by a set of wheels 21 which are configured to roll on the base 19 to translate the third mold section 16 along axis 24.

A variety of devices or mechanisms can be utilized to translate the first and third mold sections 12, 16 relative to the second mold section 14. For example, a driver element 20, such as a hydraulic actuator, can be disposed in operative communication with the first mold section 12. In use, as the driver element 20 applies a hydraulic load 22 to the first mold section 12, the first mold section 12 linearly translates along axis 18 and the third mold section 14 translates along axis 24 relative to the second mold section 14.

As indicated above, the stack mold system 10 includes a hydraulic assembly 15 which is connected to the first, second, and central mold sections 12, 14, 16. In the arrangement illustrated, the central mold section 16 is disposed in operative communication with the first mold section 12 via a first hydraulic element 34 of the hydraulic assembly 15 and is disposed in operative communication with the second mold section 14 via a second hydraulic element 36 of the hydraulic assembly 15. In use, and as will be described in detail below, as the driver element 20 applies the hydraulic load 22 to the first mold section 12, with translation of the first mold section 12 along axis 18, the hydraulic assembly 15 causes the central mold section 16 to translate along the axis 24 relative to the second mold section 14.

The hydraulic assembly 15 is configured to maintain substantial co-linear alignment of the sections 12, 14, 16 during operation, relative to a longitudinal axis 17. For example, as indicated above, the first hydraulic element 34 connects the first and third mold sections 14, 16 and the second hydraulic element 36 connects the second and third mold sections 14, 16. During operation, this minimizes rotation or misalignment of the mold sections 12, 14, 16 relative to each other and relative to longitudinal axis 17 which, in turn, minimizes binding of the mold sections 12, 14, 16.

The hydraulic assembly 15 is also configured to maintain the central mold section 16 at a substantially central location relative to the first mold section 12 and the second mold section 14 when the first mold section 12 translates along axis 18. For example, the hydraulic assembly 15 maintains substantially equal distances 26, 28 between opposed faces 62, 64 and 66, 68 of the adjacent mold sections 12, 14, 16, regardless of whether the mold sections 12, 14, 16 are closed, open, or in transition between the closed and open states. The substantially equal distances 26, 28 between opposed faces of adjacent mold sections allows the mold sections 12, 14, 16 to create seals at the corresponding parting lines 30, 32 between the first and third mold sections 12, 16 and between the third and second mold sections 16, 14 when the stack mold system 10 is disposed in a closed state.

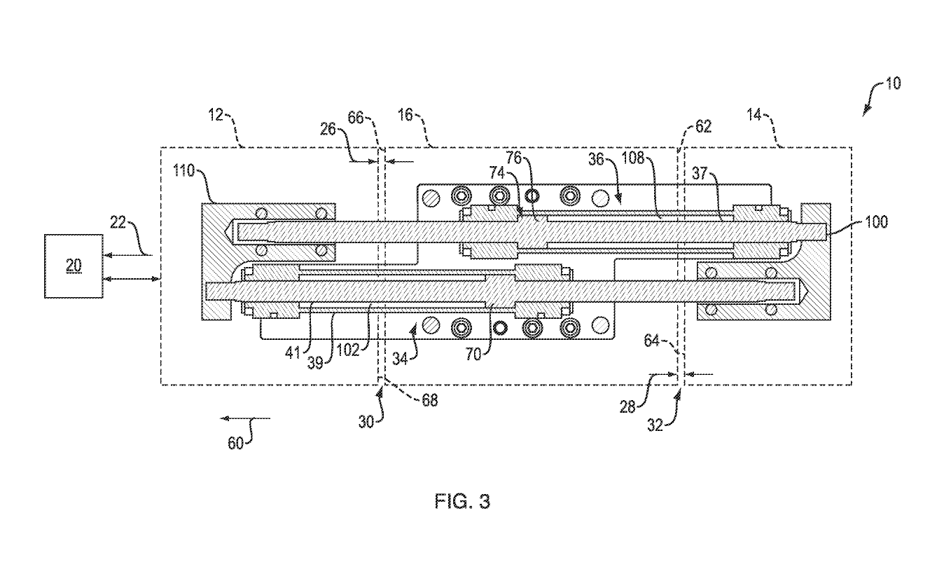

Each of the first and second hydraulic elements 34, 36 can be configured in a variety of ways. In one arrangement, the first hydraulic element 34 is configured as a double ended cylinder. For example, the first hydraulic element 34 includes a substantially hollow housing 39 connected to the central mold section 16 and which at least partially contains a first piston 41 and an associated first ram 70 connected to the first piston 41. The piston 41 includes a first end 84 which extends from a first end of the housing 39 and a second end 86 which extends from a second end of the housing 39. As indicated in FIG. 1, the first end 84 of the piston 41 is connected to the first mold section 12, such as by a mechanical coupling between the first end 84 and the first mold section 12. The second end 86 of the piston 41 is configured to slidably insert within a cavity 100 defined by the second mold section 14. For example, when the stack mold system 10 is disposed in a closed position, such as illustrated in FIG. 3, the cavity 100 of the second mold section 14 contains the second end 86 of the piston 41. Such a configuration of the second mold section 14 allows the second end of the piston 41 to translate beyond the end of the housing 39 to allow each of the first and second housings 35, 39 to maintain substantially equal fluid volumes during operation.

In one arrangement, the second hydraulic element 36 can also be configured as a double ended cylinder. For example, the second hydraulic element 36 includes a substantially hollow housing 35 coupled to the central mold section 16 and which at least partially contains a second piston 37 and an associated second ram 76 connected to the second piston 37. The piston 37 includes a first end 80 which extends from a first end of the housing 35 and a second end 82 which extends from a second end of the housing 35. As indicated in FIG. 1, the second end 82 of the piston 37 is connected to the second mold section 14, such as by a mechanical coupling between the second end 82 and the second mold section 14. The first end 80 of the piston 37 is configured to slidably insert within a cavity 110 defined by the first mold section 12. For example, when the stack mold system 10 is disposed in a closed position, such as illustrated in FIG. 3, the cavity 110 of the first mold section 12 contains the first end 80 of the piston 37. Such a configuration of the first mold section 12 allows the first end 80 of the piston 37 to translate beyond the respective housings 35, 39 in order for each respective housing 35, 39 to maintain substantially equal fluid volumes during operation.

As will be described in detail below, each piston 37, 41 includes a corresponding ram 70, 76 configured to assist in cycling a hydraulic fluid between the first and second hydraulic elements 34, 36 to drive the position of the first and central mold sections 12, 16. While the hydraulic fluid can be configured in a variety of ways, in one arrangement, the hydraulic fluid is oil or other substantially incompressible fluid held at a fluid pressure of about 3000 psi.

Returning to FIG. 1, the first ram 70 of the first hydraulic element 34 is connected to the first piston 41 and is moveably disposed within the first housing 39 while the second ram 76 of the second hydraulic element 36 is connected to the second piston 37 and is moveably disposed within the second housing 35. Each of the first and second rams 70, 76 are configured to define variable fluid volumes relative to their corresponding housings 39, 35. For example, with reference to FIG. 1, the first ram 70 defines a first volume 102 relative to a first portion 103 of the first housing 39 and defines a second volume 104 relative to a second portion 105 of the first housing 39. Also with reference to FIG. 1, the second ram 76 defines a third volume 106 relative to a first portion 107 of the second housing 35 and defines a fourth volume 108 relative to a second portion 109 of the second housing 35. As will be described below, while the hydraulic assembly 15 is configured to contain a substantially constant amount of hydraulic fluid, each of the first, second, third, and fourth volumes 102, 104, 106, 108 contain a variable amount of fluid, depending upon the position of the respective rams 70, 76 during operation.

The second hydraulic element 36 and the first hydraulic element 34 are disposed in fluid communication with each other. In one arrangement, the hydraulic assembly 15 includes a first and second fluid conduit 38, 40, each disposed in fluid communication with the first and second hydraulic elements 34, 36. For example, the first fluid conduit 38 is disposed in fluid communication with the first volume 103 of the first housing 39 and with the third volume 106 of the second housing 35. Further, the second fluid conduit 40 is disposed in fluid communication with the second volume 105 of the first housing 39 and the fourth volume 108 of the second housing. With such a configuration, the fluid conduits 38, 40 allow the fluid to cycle between the corresponding first and third volumes 103, 106 and between the second and fourth volumes 105, 108 to drive the first and second hydraulic elements 34, 36.

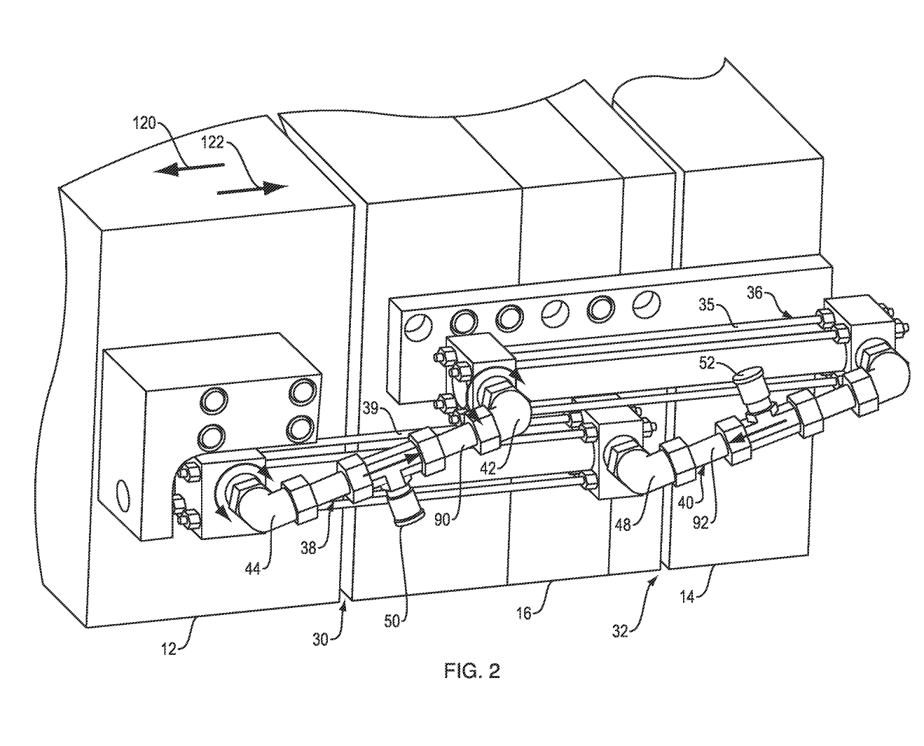

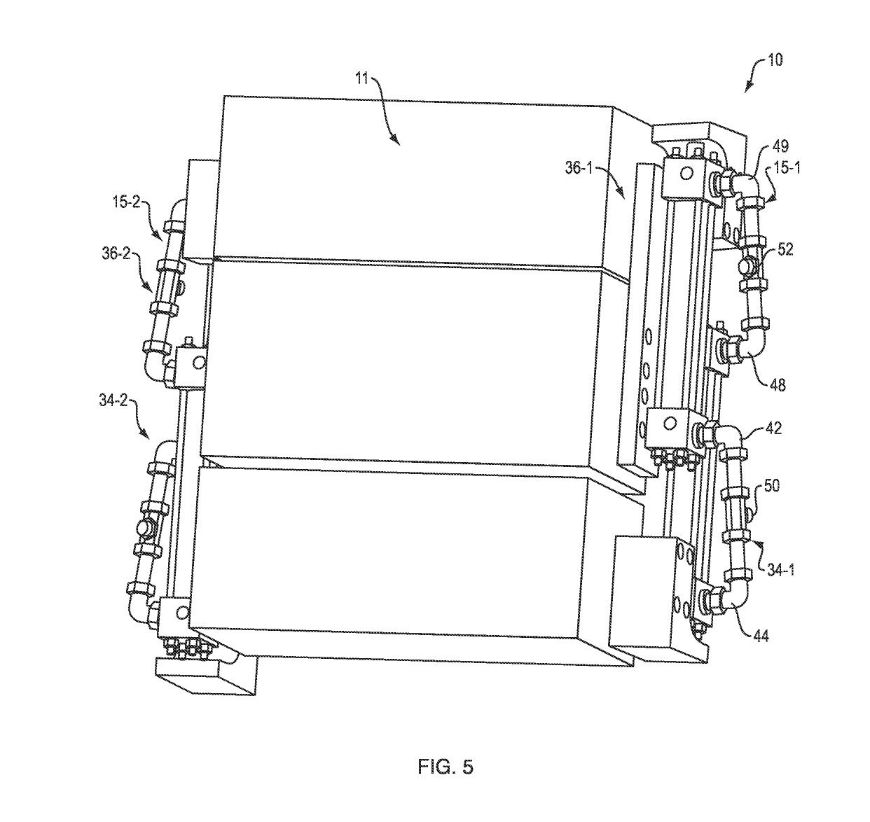

In one arrangement, the fluid conduits 38, 40 are configured as fluid connectors 90, 92 disposed substantially external to the hydraulic elements 34, 36 and to the stack mold system 10. During operation, as the first and third mold sections 14, 16 translate relative to the second mold section, the first and second connectors 90, 92 are configured to rotate relative to the first and second hydraulic elements 34, 36. For example, with reference to FIGS. 2 and 5, the first fluid connector 90 includes a first rotatable joint 44 connected to the first housing 39 and a second rotatable joint 42 coupled to the second housing 35 and the second fluid connector 92 includes a first rotatable joint 48 connected to the first housing 39 and a second rotatable joint 49 coupled to the second housing 35.

Each of the first rotatable joints 44, 48 and the second rotatable joints 42, 49 are configured to allow rotation of the first and second connectors 90, 92 from a first position to a second position when the first mold section 12 translates between a first position and a second position along the longitudinal axis 17. For example, when the first mold section 12 translates along a first direction 120, the first and second connectors 90, 92 rotate in a counterclockwise direction about rotatable joints 42, 44, 48, 49. Further, when the first mold section 12 translates along a second direction 122, the first and second connectors 90, 92 rotate in a clockwise direction about rotatable joints 42, 44, 48, 49.

In order to minimize the presence of air or other compressible fluids within the hydraulic assembly, in one arrangement, and with continued reference to FIG. 2, each of the first and second fluid connector 90, 92 includes a corresponding bleed valve 50, 52. In use, an operator opens the bleed valves and fills the hydraulic assembly 15 with a hydraulic fluid. As the hydraulic assembly 15 becomes full, the hydraulic fluid causes any air present to exit the assembly 15 via the bleed valves 50, 52. At the point where hydraulic fluid exits the bleed valves 50, 52, the air has been purged from the assembly 15 and the user can close the valves 50, 52.

In use, the hydraulic assembly 15 is configured to 15 maintain substantially equal distances 26, 28 between opposed faces 62, 64 and 66, 68 of the adjacent mold sections 12, 14, 16, regardless of whether the mold sections 12, 14, 16 are closed, open, or in transition between the closed and open states. For example, assume the case where, in a first or starting position as shown in FIGS. 2 and 3, a first face 62 of the central mold section 16 is disposed against a face 64 of the second mold section 14 and a second face 66 of the central mold section 16 is disposed against a face 68 of the first mold section 12. With such a starting position, the distance 26 between opposing faces 66, 68 is substantially equal to the distance 28 between opposing faces 62, 64.

As the driver element 20 applies a load 22 to the first mold section 12 along direction 60, both the first mold section 12 and the central mold section 16 translate along direction 60. For example, with application of the load 22, the first mold section 12 begins to open the first parting line 30 and applies a load on the piston 41 of the first hydraulic element 34 along direction 60. This loading causes the piston 41 and corresponding ram 70 to translate within the housing 39 along direction 60 and drive the hydraulic fluid within the first volume 102 into the third volume 106 of the second hydraulic element 36 via the first fluid conduit 38.

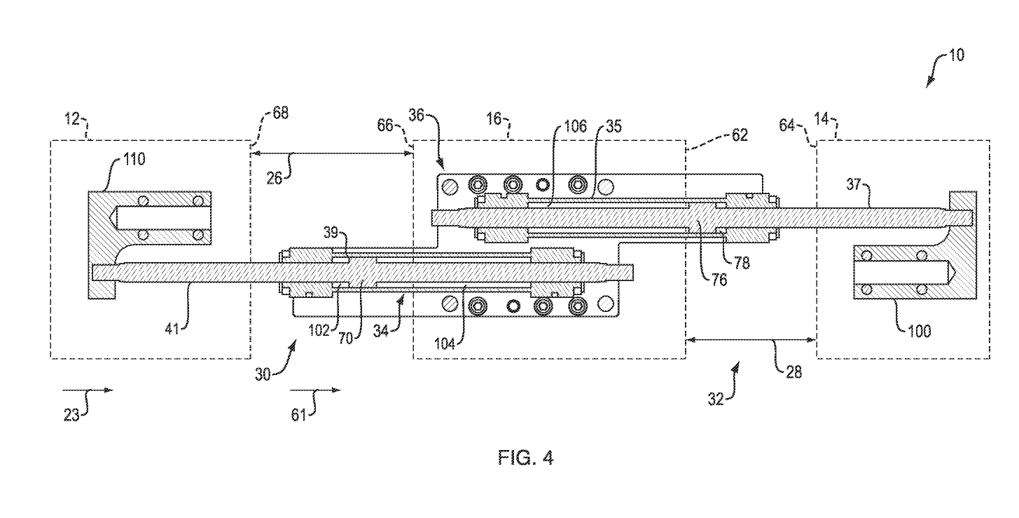

With reference to FIGS. 2 and 4, as the fluid flows into the third volume 106 defined by the housing 35 of the second hydraulic element 36 and the ram 76, the pressure within the third volume 106 causes the central mold section 16 to translate along direction 60 relative to the ram 76 and piston 37. This translation drives the central mold section 16 away from the second mold section 14 to open the second parting line 32 and maintain the central mold section 16 in a substantially centered location relative to the first and second mold sections 12, 14. Additionally, the translation of the central mold section 16 causes the fluid located within the fourth volume 108 of the second hydraulic element 36 to flow through the second fluid conduit 40 and into the second volume 104 of the first hydraulic element 34. The substantially continuous loading of the first mold section 12 by the driver element 20 allows for substantially continuous transfer of fluid from the first and fourth volumes 102, 108 into the third and second volumes 106, 104, respectively. This, in turn, maintains the distance 26 between faces 66, 68 at the first parting line 30 to be substantially equal to the distance 28 between the faces 62, 64 at the second parting line 32 as the stack mold system 10 moves between the first position shown in FIG. 3 and a second position as shown in FIG. 4.

At the point where the stack mold system 10 is disposed in the second position, the driver element 20 can apply a load 23 to the first mold section 12 along a direction 61 as shown in FIG. 4, to redispose the stack mold system 10 to the first position. Here, the fluid flow within the hydraulic assembly 15 and movement of the first and central mold sections 12, 16 is reversed. That is, with application of the load 23 by the driver element 20 and with reference to FIGS. 3 and 4, the first mold section 12 closes the first parting line 30 and applies a load on the piston 41 of the first hydraulic element 34 along direction 61. This loading causes the piston 41 and corresponding ram 70 to translate within the housing 39 along direction 61 and drive the hydraulic fluid within the second volume 104 into the fourth volume 108 of the second hydraulic element 36 via the second fluid conduit 40.

With continued reference to FIGS. 2 and 4, as the fluid flows into the fourth volume 108 of the of the second hydraulic element 36, the increased pressure within the fourth volume 108 causes the central mold section 16 to translate along direction 61 relative to the ram 76 and piston 37. This translation drives the central mold section 16 toward the second mold section 14 to close the second parting line 32 and maintain the central mold section 16 in a substantially centered location relative to the first and second mold sections 12, 14. Additionally, the translation of the central mold section 16 causes the fluid located within the third volume 106 of the second hydraulic element 36 to flow through the first fluid conduit 38 and into the first volume 102 of the second hydraulic element 36. The substantially continuous loading of the first mold section 12 by the driver element 20 allows for substantially continuous transfer of fluid from the second and third volumes 106, 104 into the first and fourth volumes 102, 108, respectively. This, in turn, maintains the distance 26 between faces 66, 68 at the first parting line 30 to be substantially equal to the distance 28 between the faces 62, 64 at the second parting line 32 as the stack mold system 10 moves between the second position shown in FIG. 4 and the first position as shown in FIG. 3.

With such a configuration, the hydraulic assembly 15 maintains the distance 28 between the opposed faces 62, 64 of the central mold section 16 and the second mold section 14 as substantially equal to the distance 26 between the opposed faces 66, 68 of the central mold section 16 and the first mold section 12. Accordingly, the use of the hydraulic assembly 15 maintains the substantially central positioning of the central mold section 16 during operation. The hydraulic assembly 15 also allows for relatively fast opening and closing of the stack mold system 10 during operation. For example, use of the hydraulic assembly 15 increases the rate of opening and closing of the stack mold system 10 to more than once every five seconds. This, in turn, provides an increase in the production capability (e.g., volume output) of the stack mold system 10. The use of the hydraulic assembly 15 also reduces costs associated with maintaining the stack mold system 10, as the hydraulic assembly 15 does not experience the wear or need for lubrication found with conventional rack and pinion assemblies.

While various embodiments of the innovation have been particularly shown and described, it will be understood by those skilled in the art that various changes in form and details may be made therein without departing from the spirit and scope of the innovation as defined by the appended claims.

As indicated above, the stack mold system 10 can include a single hydraulic assembly 15. Such indication is by way of example only. With reference to FIG. 3, the stack mold system 10 includes two hydraulic assemblies 15-1, 15-2, each mounted to opposite sides of the central mold section 16 of the stack mold system 10. For example, the stack mold system 10 is configured such that a first and second hydraulic element 34-1, 36-1 of the first hydraulic assembly 15-1 is disposed on a first lateral side of the stack mold assembly 11 and a third and fourth hydraulic element 34-2, 36-2 of the first hydraulic assembly 15-1 is disposed on a second, opposing lateral side of the stack mold assembly 11. With such a configuration, the hydraulic assemblies 15-1, 15-2 provide for substantially balanced loading of the stack mold assembly during operation. Accordingly, the hydraulic assemblies 15-1, 15-2 minimizes binding of the mold sections 12, 14, 16 during operation.

As indicated above, the hydraulic elements 34, 36 are disposed in fluid communication with each other via fluid conduits 38, 40 to create a closed hydraulic system. With reference to FIGS. 2 and 5, the fluid conduits 38, 40 are configured as fluid connectors 90, 92 disposed substantially external to the hydraulic elements 34, 36. Such indication is by way of example only. In one arrangement, the fluid conduits 38, 40 are configured as one or more manifolds disposed internally within the stack mold system 10 to fluidly couple the hydraulic elements 34, 36.

As indicated above, the stack mold system 10 includes a first mold section 12, a second, fixed mold section 14, and a central mold section 16 disposed between the first and second mold sections 12, 14. In one arrangement, the central mold section 16 is configured as a set of central mold section components. For example, the central mold section can be configured with two distinct mold sections. In another example, the central mold section can be configured with three mold sections. In such arrangements, the hydraulic assembly 15 can be connected between the multiple central mold sections. In use, the stack mold system 10 is configured to translate the first mold section 12 from the central mold section 16, translate the central mold section 16 from the fixed mold section 14, as described above, and is configured to open and close the individual mold sections of the central mold section 16 relative to each other.

What is claimed is:

1. A stack mold system, comprising:
a stack mold assembly having a first mold section, a second mold section, and a central mold section disposed between the first and second mold sections; and
at least one hydraulic assembly connected to the first mold section, the second mold section, and the central mold section, the at least one hydraulic assembly comprising:
a first hydraulic element connected to the second mold section and to the central mold section, and
a second hydraulic element connected to the first mold section and to the central mold section, the second hydraulic element disposed in fluid communication with the first hydraulic element,
the at least one hydraulic assembly configured to translate the first mold section and the central mold section along a longitudinal axis relative to the second mold section.

2. The stack mold system of claim 1, wherein:
the first hydraulic element comprises a first housing and a first piston at least partially disposed within the first housing, the first piston connected to the first mold section and the housing connected to the central mold section; and
the second hydraulic element comprises a second housing and a second piston at least partially disposed within the second housing, the second piston connected to the second mold section and the housing connected to the central mold section.

3. The stack mold system of claim 2, wherein:
the first hydraulic element further comprises a first ram connected to the first piston and moveably disposed within the first housing, the first ram defining a first volume relative to a first portion of the first housing and defining a second volume relative to a second portion of the first housing; and
the second hydraulic element further comprises a second ram connected to the second piston and moveably disposed within the second housing, the second ram defining a third volume relative to a first portion of the second housing and defining a fourth volume relative to a second portion of the second housing.

4. The stack mold system of claim 3, comprising:
a first conduit disposed in fluid communication with the first volume of the first housing and with the third volume of the second housing; and
a second conduit disposed in fluid communication with the second volume of the first housing and the fourth volume of the second housing.

5. The stack mold system of claim 4, wherein:
the first conduit comprises a first fluid connector having a first rotatable joint connected to the first housing and a second rotatable joint coupled to the second housing, the first rotatable joint and the second rotatable joint configured to allow rotation of the first fluid connector from a first position to a second position when the first mold section translates between a first position and a second position along the longitudinal axis; and
the second conduit comprises second fluid connector having a first rotatable joint connected to the first housing and a second rotatable joint coupled to the second housing, the first rotatable joint and the second rotatable joint configured to allow rotation of the second fluid connector from a first position to a second position when the first mold section translates between the first position and the second position along the longitudinal axis.

6. The stack mold system of claim 2, wherein the first hydraulic element is configured as a double ended cylinder having a first end of the first piston connected to the first mold section and a second end of the first piston configured to slidably insert within a cavity defined by the second mold section.

7. The stack mold system of claim 6, wherein the second hydraulic element is configured as a double ended cylinder having a first end of the second piston configured to slidably insert within a cavity defined by the first mold section and a second end of the second piston connected to the second mold section.

8. The stack mold system of claim 1, wherein the at least one hydraulic assembly comprises a first hydraulic assembly and a second hydraulic assembly, the first hydraulic assembly connected to a first portion of the stack mold assembly and the second hydraulic assembly connected to a second portion of the stack mold assembly.

9. The stack mold system of claim 8, wherein:
the first hydraulic assembly comprises:
the first hydraulic element connected to the second mold section and to the central mold section on a first lateral side of the stack mold assembly, and
the second hydraulic element connected to the first mold section and to the central mold section on the first lateral side of the stack mold assembly, the second hydraulic element disposed in fluid communication with the first hydraulic element; and
the second hydraulic assembly comprises:
a third hydraulic element connected to the second mold section and to the central mold section on a second lateral side of the stack mold assembly, and
a fourth hydraulic element connected to the first mold section and to the central mold section on the second lateral side of the stack mold assembly, the third hydraulic element disposed in fluid communication with the fourth hydraulic element.

10. The stack mold system of claim 1, comprising a driver element connected to the first mold section, the driver element configured to apply a hydraulic load to the first mold section to translate the first mold section and the central mold section along the longitudinal axis between a first position and a second position relative to the second mold section.

11. A hydraulic assembly for a stack mold assembly having a first mold section, a second mold section, and a central mold section disposed between the first and second mold sections, comprising:
a first hydraulic element configured to connect to the second mold section and to the central mold section; and
a second hydraulic element configured to connect to the first mold section and to the central mold section, the second hydraulic element disposed in fluid communication with the first hydraulic element, the first hydraulic element and the second hydraulic element configured to translate the first mold section and the central mold section along a longitudinal axis relative to the second mold section.

12. The stack mold system of claim 11, wherein:
the first hydraulic element comprises a first housing and a first piston at least partially disposed within the first housing, the first piston connected to the first mold section and the housing connected to the central mold section; and
the second hydraulic element comprises a second housing and a second piston at least partially disposed within the second housing, the second piston connected to the second mold section and the housing connected to the central mold section.

13. The stack mold system of claim 12, wherein:
the first hydraulic element further comprises a first ram connected to the first piston and moveably disposed within the first housing, the first ram defining a first volume relative to a first portion of the first housing and defining a second volume relative to a second portion of the first housing; and
the second hydraulic element further comprises a second ram connected to the second piston and moveably disposed within the second housing, the second ram defining a third volume relative to a first portion of the second housing and defining a fourth volume relative to a second portion of the second housing.

14. The stack mold system of claim 13, comprising:
a first conduit disposed in fluid communication with the first volume of the first housing and with the third volume of the second housing; and
a second conduit disposed in fluid communication with the second volume of the first housing and the fourth volume of the second housing.

15. The stack mold system of claim 14, wherein:
the first conduit comprises a first fluid connector having a first rotatable joint connected to the first housing and a second rotatable joint coupled to the second housing, the first rotatable joint and the second rotatable joint configured to allow rotation of the first conduit from a first position to a second position when the first mold section translates between a first position and a second position along the longitudinal axis; and
the second conduit comprises a second fluid connector having a first rotatable joint connected to the first housing and a second rotatable joint coupled to the second housing, the first rotatable joint and the second rotatable joint configured to allow rotation of the second fluid connector from a first position to a second position when the first mold section translates between a first position and a second position along the longitudinal axis.

16. The stack mold system of claim 12, wherein the first hydraulic element is configured as a double ended cylinder having a first end of the first piston connected to the first mold section and a second end of the first piston configured to slidably insert within a cavity defined by the second mold section.

17. The stack mold system of claim 16, wherein the second hydraulic element is configured as a double ended cylinder having a first end of the second piston configured to slidably insert within a cavity defined by the first mold section and a second end of the second piston connected to the second mold section.

18. A stack mold system, comprising:
a stack mold assembly having a first mold section, a second mold section, and a central mold section disposed between the first and second mold sections;
at least one hydraulic assembly connected to the first mold section, the second mold section, and the central mold section, the at least one hydraulic assembly comprising:
a first hydraulic element connected to the second mold section and to the central mold section, and
a second hydraulic element connected to the first mold section and to the central mold section;
a first conduit disposed in fluid communication with a first volume of the first hydraulic element and with a first volume of the second hydraulic element; and
a second conduit disposed in fluid communication with a second volume of the first hydraulic element and a second volume of the second hydraulic element;
the at least one hydraulic assembly configured to translate the first mold section and the central mold section along a longitudinal axis relative to the second mold section in response to a flow of fluid between the first volume of the first hydraulic element and the first volume of the second hydraulic element via the first conduit and in response to a flow of fluid between the second volume of the first hydraulic element and second volume of the second hydraulic element.
